(19) United States
(12) Patent Application Publication
(10) Pub. No.: US 2009/0215439 A1
(43) Pub. Date: Aug. 27, 2009

(54) TECHNIQUES TO MANAGE AUDIO SETTINGS

(75) Inventors: Craig Hamilton, Sunnyvale, CA (US); Peter Skillman, San Carlos, CA (US)

Correspondence Address: KACVINSKY LLC;4500 BROOKTREE ROAD, SUITE 102, WEXFORD, PA, 15090, US

(73) Assignee: PALM, INC., Sunnyvale, CA (US)

(21) Appl. No.: 12/038,602

(22) Filed: Feb. 27, 2008

(51) Int. Cl. H04M 3/00; G08B 21/00

(52) U.S. Cl. 455/418; 340/686.6

(57) ABSTRACT

Techniques to manage audio settings are described. For example, a mobile computing device may comprise an audio management module to receive information from a sensor and automatically adjust at least one audio setting based on the information. Other embodiments are described and claimed.

### BACKGROUND

Mobile computing devices, such as smart phones, may provide various processing capabilities. For example, mobile devices may provide personal digital assistant (PDA) features, including word processing, spreadsheets, synchronization of information (e.g., e-mail) with a desktop computer, and so forth. In addition, such devices may have wireless communications capabilities. More particularly, mobile devices may employ various communications technologies to provide features, such as mobile telephony, mobile e-mail access, web browsing, and content (e.g., video and radio) reception. Exemplary wireless communications technologies include cellular, satellite, and mobile data networking technologies.

Providing such an array of functionality in a single device provides users with a variety of options in selecting programs and multitasking using their mobile computing device. When multitasking, it is advantageous to have the ability to quickly switch between programs with limited user interaction. As a result, it is desirable to enhance the automation of certain tasks. For example, it may be advantageous to automatically adjust audio settings of the mobile computing device based on predetermined criteria. Consequently, there exists a substantial need for techniques to improve the management of audio settings.

### BRIEF DESCRIPTION OF THE DRAWINGS

FIG. 1A illustrates one embodiment of a first mobile computing device.

FIG. 1B illustrates one embodiment of a user diagram.

FIG. 2A illustrates one embodiment of a first logic diagram.

FIG. 2B illustrates one embodiment of a second logic diagram.

FIG. 3 illustrates one embodiment of third logic diagram.

FIG. 4 illustrates one embodiment of a second mobile computing device.

### DETAILED DESCRIPTION

Various embodiments may be generally directed to audio management techniques for a mobile computing device, such as a smart phone. Some embodiments may be particularly directed to audio management techniques for a mobile computing device based on information received from a sensor.

In one embodiment, for example, a mobile computing device may include an audio management module, a sensor and a speaker system. In various embodiments, the information received from the sensor may include a characteristic of an object. One example of an object may include a human body part. In various embodiments, the audio management module may use the signals received from the sensor to automatically adjust at least one audio setting. One example of an audio setting may include the output volume of at least one speaker of the speaker system.

The mobile computing device may further include a processor coupled to the sensor and the speaker system. The processor may be operative to execute the audio management module. The mobile computing device may further include a memory coupled to the processor. The memory may be operative to store the audio management module. Other embodiments are described and claimed.

Automatically controlling an audio setting based on information received from a sensor may provide several advantages. For example, if a user involved in a telephone conversation using their mobile computing device chooses to access a program other than the telephone program, such as a calendar program for example, it may be advantageous to automatically adjust an audio setting. If a user involved in a telephone conversation were to place their mobile computing device down on a table to access a calendar program, for example, it may be advantageous for the mobile computing device to automatically switch to speakerphone mode so that the user can continue her telephone conversation and access additional functionality of the mobile computing device without having to manually switch the mobile computing device into speakerphone mode. Other embodiments are described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include other combinations of elements in alternate arrangements as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

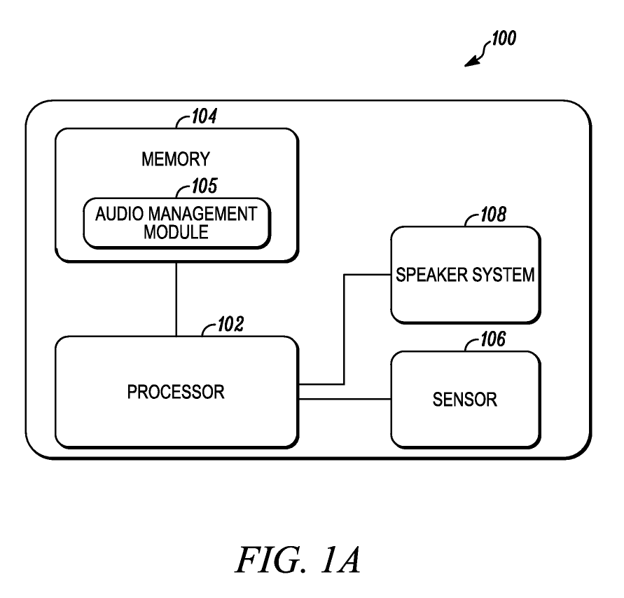

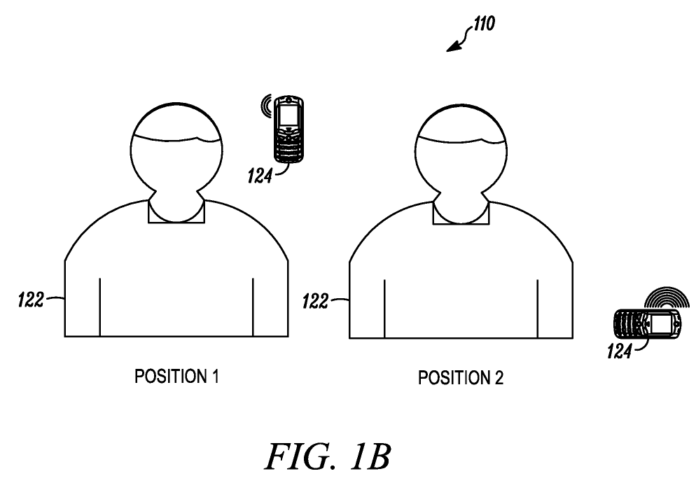

FIG. 1A illustrates one embodiment of an apparatus. In particular, FIG. 1A shows a first embodiment of a mobile computing device 100. The mobile computing device 100 may include by way of example and not limitation a processor 102, a memory 104, an audio management module 105, a sensor 106 and a speaker system 108. These elements or portions of these elements may be implemented in hardware, software, firmware, or in any combination thereof. The embodiments are not limited to these depicted elements.

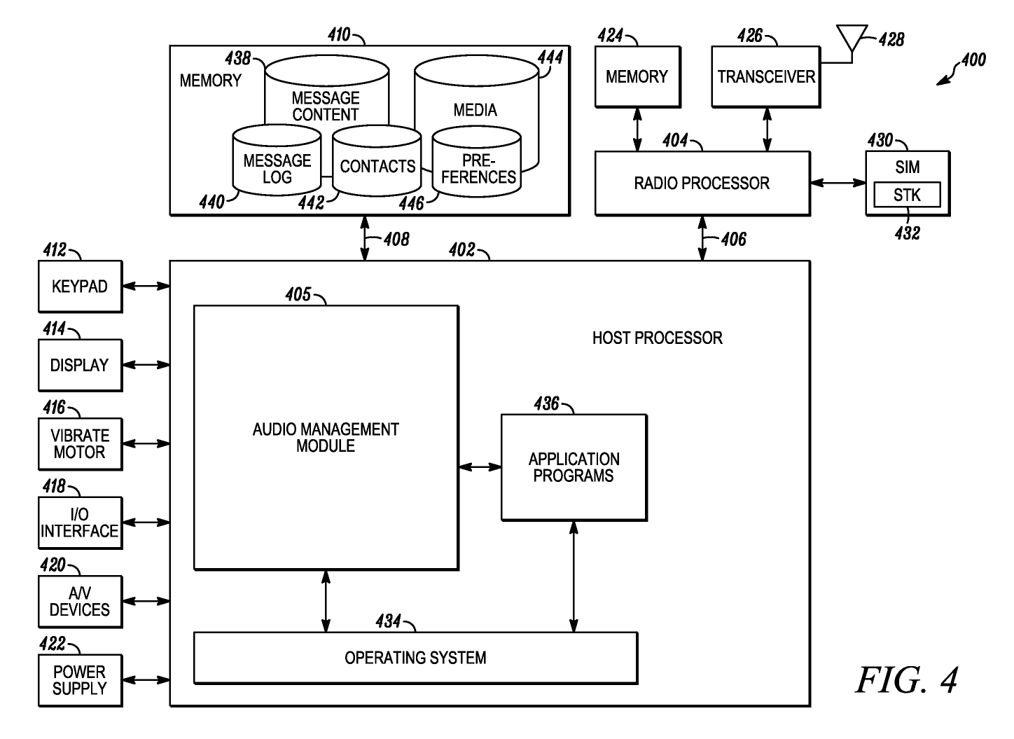

The mobile computing device 100 may be generally configured to support or provide cellular voice communication, wireless data communication and computing capabilities. The mobile computing device 100 may be implemented as a combination handheld computer and mobile telephone, sometimes referred to as a smart phone. Examples of smart phones include, for example, Palm® products such as Palm® Treo™ smart phones. Although some embodiments may be described with the mobile computing device 100 implemented as a smart phone by way of example, it may be appreciated that the embodiments are not limited in this context. For example, the mobile computing device 100 may comprise, or be implemented as, any type of wireless device, mobile station, or portable computing device with a self-contained power source (e.g., battery) such as a laptop computer, ultra-laptop computer, personal digital assistant (PDA), cellular telephone, combination cellular telephone/PDA, mobile unit, subscriber station, user terminal, portable computer, handheld computer, palmtop computer, wearable computer, media player, pager, messaging device, data communication device, and so forth. Additional details for a mobile computing device may be described in more detail with reference to FIG. 4.

The processor 102 may comprise a general purpose processor or an application specific processor arranged to provide general or specific computing capabilities for the communications system 100. For example, the processor 102 may perform operations associated with higher layer protocols and applications. For instance, the processor 102 may be implemented as a host processor to provide various user applications, such as telephony, text messaging, e-mail, web browsing, word processing, video signal display, and so forth. In addition, the processor 102 may provide one or more functional utilities that are available to various protocols, operations, and/or applications. Examples of such utilities include operating systems, device drivers, user interface functionality, and so forth.

The memory 104 may comprise computer-readable media such as volatile or non-volatile memory units arranged to store programs and data for execution by the processor 102. As depicted in FIG. 1A, the memory 104 may store an audio management module 105 in the form of executable program instructions, code or data. The processor 102 may retrieve and execute the program instructions, code or data from the memory 104 to control or provide audio management operations for the mobile computing device 100. Although the audio management module 105 is shown as part of the memory 104 for execution by the processor 102, it may be appreciated that the audio management module 105 may be stored and executed by other memory and processing resources available to the mobile computing device 100. Further, although the audio management module 105 is depicted as software executed by a processor, it may be appreciated that the operations for the audio management module 105 may be implemented in hardware as well using one or more integrated circuits, for example. The embodiments are not limited in this context.

The sensor 106 may comprise any type of transducer which uses energy or any other type of signal and converts it into a reading for the purpose of information transfer. In various embodiments, sensor 106 may comprise a proximity sensor, ultrasound sensor, electrical resistance sensor, magnetic sensor, pressure sensor, thermal sensor, infrared sensor, light sensor or temperature sensor, for example.

In various embodiments, sensor 106 may comprise a proximity sensor. A proximity sensor may comprise any sensor able to detect the presence of nearby objects without any physical contact. In various embodiments, the proximity sensor may emit an electromagnetic or electrostatic field or a beam of electromagnetic radiation and look for changes in the field or return signal to determine a distance between the sensor and the nearby object. For example, a proximity sensor contained in mobile computing device 100 may be able to detect the presence of an object near the device. In various embodiments, a proximity sensor may be configured to determine a distance between mobile computing device 100 and a human body part such as a human head, for example.

In various embodiments, sensor 106 may comprise a thermal sensor. A thermal sensor may comprise, for example, a thermometer, a thermocouple, a temperature sensitive resistor, a thermistor, a bi-metal thermometers or a thermostat. A thermal sensor contained in mobile computing device 100 may be configured to detect, for example, a human body temperature when mobile computing device 100 is raised by a user for use as a mobile telephone near the head of the user. The temperature measured by sensor 106 when mobile computing device 100 is used near the head of a user, for example, may differ from the temperature measured when mobile computing device 100 is not located near the head of a user.

Sensor 106 may comprise an optical sensor in various embodiments. An optical sensor may comprise an infrared sensor, photocell, photodiode, or phototransistor, for example. An optical sensor may be used to detect changes in light at the sensor. For example, when mobile computing device 100 is used near the head of a user, an optical sensor may be configured to detect a decrease in the amount of light contrasted with the amount of light detected when the sensor 106 or the mobile computing device 100 is not located near the head of a user.

In various embodiments, sensor 106 may comprise an acoustic sensor, such as an ultrasound sensor capable of detecting time-of-flight echo return, for example. In various embodiments, sensor 106 may comprise an accelerometer capable of detecting the position of mobile computing device 100 relative to a defined starting position. For example, if the defined starting position is parallel to the ground, the accelerometer may be configured to detect movement of the mobile computing device 100 from the parallel position into a perpendicular position with respect to the ground. Other embodiments are described and claimed.

While sensor 106 is shown as part of mobile computing device 100 by way of example, it should be understood that sensor 106 may comprise a sensor that is not part of mobile computing device 100 in various embodiments. In various embodiments, sensor 106 may comprise a sensor that is located remote from mobile computing device 100 and is communicably coupled to mobile computing device 100. For example, sensor 106 may comprise a sensor connected to the roof of a convertible car, capable of sending a signal to mobile computing device 100 to indicate the status of the roof, e.g. closed or open. In this manner, audio management module 105 may automatically configure audio settings based on the status of the convertible roof, for example, as detected by sensor 106. Other embodiments are described and claimed.

Speaker system 108 may comprise one or more electromechanical transducers that convert an electrical signal to sound. Speaker system 108 may be configured to provide stereophonic or monophonic sound, for example. In various embodiments, speaker system 108 may comprise two or more speakers. In various embodiments, a first speaker may be configured for a close range audio mode and a second speaker may be configured for a broadcast audio mode. In various embodiments, the first or second speaker may be located remote from the mobile computing device 100. For example, the first or second speaker may be located in a Bluetooth headset device.

In general operation, the mobile computing device 100 may comprise an audio management module 105 to receive information from a sensor 106 and automatically adjust at least one audio setting based on the information. Mobile computing device 100 may include a user setting or preference to enable or disable audio management module 105 in various embodiments.

Audio management module 105 may receive information from sensor 106 of mobile computing device 100 and use this information to automatically adjust the output volume of speaker system 108, for example. In various embodiments, the information received from sensor 106 may comprise a characteristic of an object such as, for example, a distance between the object and sensor 106 or a temperature of the object as measured by sensor 106. The object may comprise a human body part such as the human head in various embodiments.

In various embodiments, the least one audio setting that is automatically adjusted may be the output volume of speaker system 108. The output volume may include the intensity of sound produced by speaker system 108. The output volume of speaker system 108 may be increased or decreased automatically based on information received from sensor 106, for example.

In various embodiments, sensor 106 may comprise a proximity sensor and the information received from sensor 106 may comprise a distance between the proximity sensor 106 and an object. The output volume of speaker system 108 may be adjusted in response to a change in distance between sensor 106 and the object in various embodiments. For example, the output volume may be increased as the distance between sensor 106 and the object increases and decreased as the distance between the sensor 106 and the object decreases.

In various embodiments, sensor 106 may comprise a thermal sensor and the information may comprise a temperature of an object near the sensor 106. The output volume of speaker system 108 may be adjusted in response to a change in temperature measured at sensor 106. For example, the output volume of speaker system 108 may be increased as the temperature measured at sensor 106 decreases and decreased as the temperature measured at sensor 106 increases. In various embodiments, the temperature measured by sensor 106 may be higher when mobile computing device is near a human head, for example, as a result of the average human body temperature being higher than the air temperature in many circumstances.

FIG. 1B illustrates a user and a mobile computing device in two different configurations. In particular, FIG. 1B shows user 122 and mobile computing device 124 in position 1 and mobile computing device 124 in position 2. Mobile computing device 124 may be representative of mobile computing device 100 of FIG. 1A and may contain any of the sensors described above with respect to FIG. 1A in various embodiments.

In position 1, a sensor of mobile computing device 124 may detect that the head of user 122 is in close proximity. The output volume of mobile computing device 124 may be automatically adjusted as a result of the proximity to the head of user 122. When mobile computing device 124 is moved away from the head of user 122, into position 2 for example, the output volume of mobile computing device 124 may be increased based on its new position. The output volume of mobile computing device 124 may be decreased as mobile computing device 124 is moved closer to the head of user 122, into position 1 for example. The automatic adjustment of audio settings may be advantageous because it may enhance the user experience and may additionally operate as a safety feature to prevent damage to the hearing of user 122 as a result of an output volume having an intensity that is too great for close range use.

A first audio mode or a second audio mode may be automatically selected in various embodiments. For example, the first audio mode may comprise a close range audio mode and the second audio mode may comprise a broadcast audio mode. In various embodiments, the close range audio mode and broadcast audio mode are configured to use a single speaker and the output volume is increased or decreased in response to the selection of the different audio modes respectively. In some embodiments, the close range audio mode is configured to use a first speaker and the broadcast audio mode is configured to use a second speaker. For example, a first speaker may be used for lower volumes associated with close range audio mode and a second speaker may be used for higher volumes associated with broadcast audio mode.

In various embodiments, the output volume in close range audio mode may be configured to be suitable for a conventional telephone conversation with mobile computing device 124 in close proximity to the head of user 122 as illustrated in position 1, for example. The output volume in broadcast audio mode may be such that user 122 would be capable of hearing the output in situations where mobile computing device 124 was not positioned near the head of the user 122 as illustrated in position 2, for example. Broadcast audio mode could be used, for example, if mobile computing device 124 were placed on a table during a speakerphone telephone conversation. Other embodiments are described and claimed.

In various embodiments, switching between the first audio mode and the second audio mode may be based on a threshold value that is compared to a measurement made by a sensor of the mobile computing device. The threshold value may be a predetermined value based on the type of sensor being used in the mobile computing device. For example, if the sensor being used is a proximity sensor, the threshold value may be a distance such as six inches from an object. If the sensor is a thermal sensor, the threshold value may be a temperature such as ninety six degrees Fahrenheit, for example. While certain threshold values are shown by way of example, it should be understand that any threshold value could be selected based on the desired results and still fall within the scope of the embodiments described and claimed herein.

Operations for the above embodiments may be further described with reference to the following figures and accompanying examples. Some of the figures may include a logic diagram. Although such figures presented herein may include a particular logic diagram, it can be appreciated that the logic diagram merely provides an example of how the general functionality as described herein can be implemented. Further, the given logic diagram does not necessarily have to be executed in the order presented, unless otherwise indicated. In addition, the given logic diagram may be implemented by a hardware element, a software element executed by a processor, or any combination thereof. The embodiments are not limited in this context.

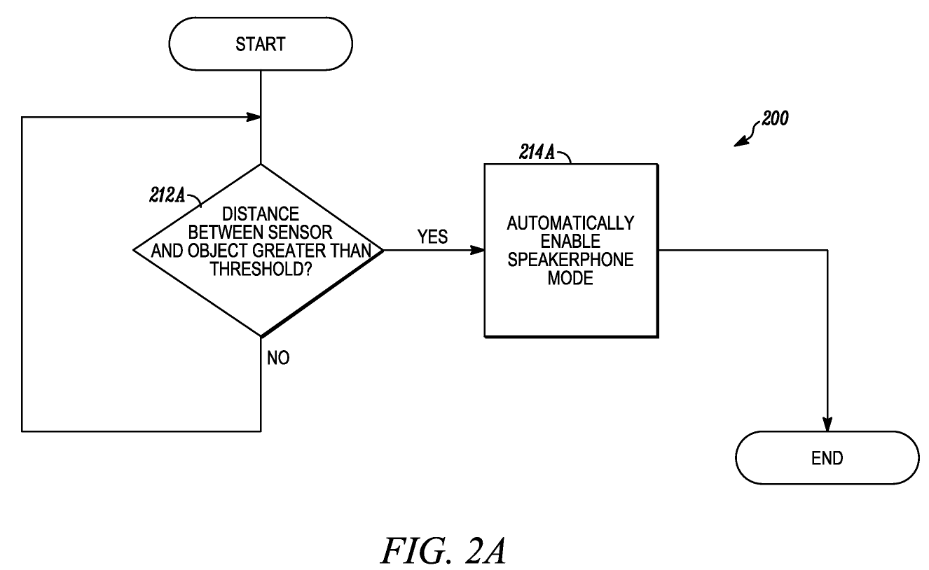

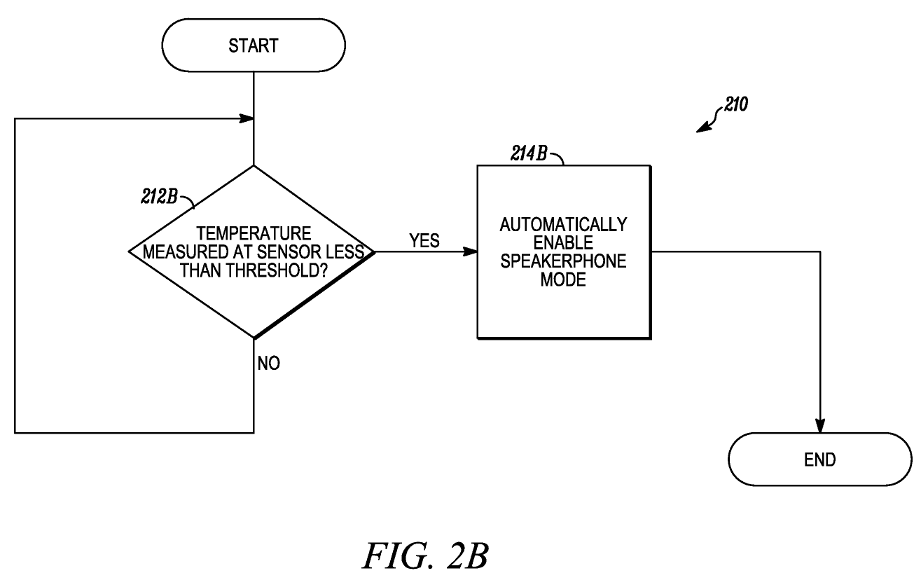

FIG. 2A illustrates a first embodiment of a logic diagram. FIG. 2A illustrates an embodiment in which mobile computing device 100 includes a proximity sensor 106, for example. In various embodiments, mobile computing device 100 may be configured to start in a first audio mode. At 212A, a distance between the proximity sensor 106 and an object is compared to a threshold value. If the distance is less than the threshold value, mobile computing device 100 remains in the first audio mode and sensor 106 continues to monitor the distance between the sensor 106 and the object. If the distance between the sensor 106 and the object is greater than the threshold value, mobile computing device 100 may automatically switch to a second audio mode. The second audio mode may include speakerphone mode in various embodiments.

FIG. 2B illustrates a second embodiment of a logic diagram. FIG. 2B illustrates an embodiment in which mobile computing device 100 includes a temperature sensor 106, for example. In various embodiments, mobile computing device 100 may be configured to start in a first audio mode. At 212B, a temperature is measured at sensor 106 and the temperature is compared to a threshold value. If the temperature measured at the sensor 106 is greater than the threshold value, mobile computing device 100 remains in the first audio mode and sensor 106 continues to monitor a temperature. If the temperature measured at the sensor 106 is less than the threshold value, mobile computing device 100 may automatically switch to a second audio mode. The second audio mode may include speakerphone mode in various embodiments.

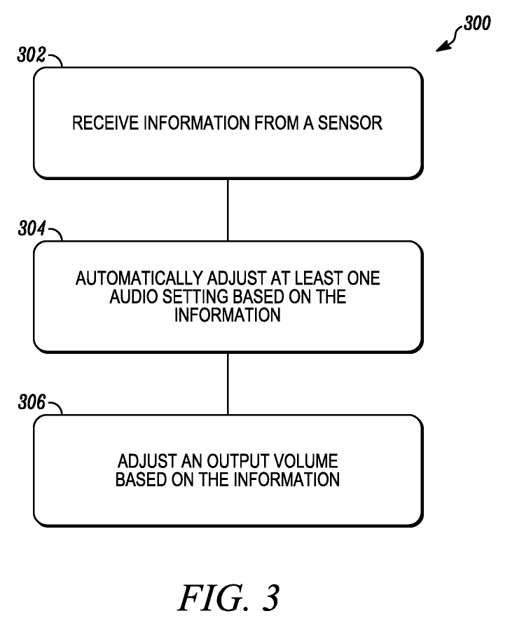

FIG. 3 illustrates a third embodiment of a logic diagram. In particular, FIG. 3 illustrates a logic diagram 300, which may be representative of the operations executed by one or more embodiments described herein. As shown in the FIG. 3, information may be received from a sensor at 302 and at least one audio setting may be automatically adjusted based on the information at 304. At 306, an output volume may be adjusted based on the information. For example, the mobile computing device 100 may receive information from sensor 106 and may adjust the output volume of speaker system 108 based on the information.

In one embodiment, a distance between a sensor and an object may be determined and an output volume may be adjusted in response to a change in distance between the sensor and the object. For example, a distance between sensor 106 of mobile computing device 100 and a human head may be determined and the output volume of speaker system 108 may be increased as the distance between the sensor 106 and the human head increases or decreased as the distance between the sensor 106 and the human head decreases. In various embodiments, an output volume may be adjusted in response to a change in temperature measured at a sensor. For example, the output volume of speaker system 108 may be increased as the temperature measured at sensor 106 decreases or decreased as the temperature measured at the sensor 106 increases.

In various embodiments, a first audio mode configured for close range audio operation using a first speaker may be selected or a second audio mode configured for broadcast audio operation using a second speaker may be selected. For example, a close range audio mode configured for use in a conventional telephone conversation may be selected based on information received from sensor 106, or a broadcast audio mode such as speakerphone mode may be selected based on the received information. Other embodiments are described and claimed.

FIG. 4 illustrates a block diagram of a mobile computing device 400 suitable for implementing various embodiments, including the mobile computing device 100. It may be appreciated that the mobile computing device 400 is only one example of a suitable mobile computing environment and is not intended to suggest any limitation as to the scope of use or functionality of the embodiments. Neither should the mobile computing device 400 be interpreted as having any dependency or requirement relating to any one or combination of components illustrated in the exemplary mobile computing device 400.

The host processor 402 (e.g., similar to the processor 102) may be responsible for executing various software programs such as system programs and applications programs to provide computing and processing operations for the mobile computing device 400. The radio processor 404 may be responsible for performing various voice and data communications operations for the mobile computing device 400 such as transmitting and receiving voice and data information over one or more wireless communications channels. Although the mobile computing device 400 is shown with a dual-processor architecture, it may be appreciated that the mobile computing device 400 may use any suitable processor architecture and/or any suitable number of processors in accordance with the described embodiments. In one embodiment, for example, the processors 402, 404 may be implemented using a single integrated processor.

The host processor 402 may be implemented as a host central processing unit (CPU) using any suitable processor or logic device, such as a as a general purpose processor. The host processor 402 may also be implemented as a chip multiprocessor (CMP), dedicated processor, embedded processor, media processor, input/output (I/O) processor, co-processor, microprocessor, controller, microcontroller, application specific integrated circuit (ASIC), field programmable gate array (FPGA), programmable logic device (PLD), or other processing device in accordance with the described embodiments.

As shown, the host processor 402 may be coupled through a memory bus 408 to a memory 410. The memory bus 408 may comprise any suitable interface and/or bus architecture for allowing the host processor 402 to access the memory 410. Although the memory 410 may be shown as being separate from the host processor 402 for purposes of illustration, it is worthy to note that in various embodiments some portion or the entire memory 410 may be included on the same integrated circuit as the host processor 402. Alternatively, some portion or the entire memory 410 may be disposed on an integrated circuit or other medium (e.g., hard disk drive) external to the integrated circuit of the host processor 402. In various embodiments, the mobile computing device 400 may comprise an expansion slot to support a multimedia and/or memory card, for example.

The memory 410 may be implemented using any computer-readable media capable of storing data such as volatile or non-volatile memory, removable or non-removable memory, erasable or non-erasable memory, writeable or re-writeable memory, and so forth. Examples of computer-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The mobile computing device 400 may comprise an alphanumeric keypad 412 coupled to the host processor 402. The keypad 412 may comprise, for example, a QWERTY key layout and an integrated number dial pad. The mobile computing device 400 also may comprise various keys, buttons, and switches such as, for example, input keys, preset and programmable hot keys, left and right action buttons, a navigation button such as a multidirectional navigation button, phone/send and power/end buttons, preset and programmable shortcut buttons, a volume rocker switch, a ringer on/off switch having a vibrate mode, and so forth. The keypad 412 may comprise a physical keypad using hard buttons, or a virtual keypad using soft buttons displayed on a display 414.

The mobile computing device 400 may comprise a display 414 coupled to the host processor 402. The display 414 may comprise any suitable visual interface for displaying content to a user of the mobile computing device 400. In one embodiment, for example, the display 414 may be implemented by a liquid crystal display (LCD) such as a touch-sensitive color (e.g., 46-bit color) thin-film transistor (TFT) LCD screen. The touch-sensitive LCD may be used with a stylus and/or a handwriting recognizer program.

The mobile computing device 400 may comprise a vibrate motor 416 coupled to the host processor 402. The vibrate motor 416 may be enable or disabled according to the preferences of the user of the mobile computing device 400. When enabled, the vibrate motor 416 may cause the mobile computing device 400 to move or shake in a generic and/or patterned fashion in response to a triggering event such as the receipt of a telephone call, text message, an alarm condition, a game condition, and so forth. Vibration may occur for a fixed duration and/or periodically according to a pulse.

The mobile computing device 400 may comprise an input/output (I/O) interface 418 coupled to the host processor 402. The I/O interface 418 may comprise one or more I/O devices such as a serial connection port, an infrared port, integrated Bluetooth wireless capability, and/or integrated 802.11x (WiFi) wireless capability, to enable wired (e.g., USB cable) and/or wireless connection to a local computer system, such as a local personal computer (PC). In various implementations, mobile computing device 400 may be arranged to synchronize information with a local computer system.

The host processor 402 may be coupled to various audio/video (A/V) devices 420 that support A/V capability of the mobile computing device 400. Examples of A/V devices 420 may include, for example, a microphone, one or more speakers (such as speaker system 108), an audio port to connect an audio headset, an audio coder/decoder (codec), an audio player, a Musical Instrument Digital Interface (MIDI) device, a digital camera, a video camera, a video codec, a video player, and so forth.

The host processor 402 may be coupled to a power supply 422 arranged to supply and manage power to the elements of the mobile computing device 400. In various embodiments, the power supply 422 may be implemented by a rechargeable battery, such as a removable and rechargeable lithium ion battery to provide direct current (DC) power, and/or an alternating current (AC) adapter to draw power from a standard AC main power supply.

The radio processor 404 may be arranged to communicate voice information and/or data information over one or more assigned frequency bands of a wireless communication channel. The radio processor 404 may be implemented as a communications processor using any suitable processor or logic device, such as a modem processor or baseband processor. The radio processor 404 may also be implemented as a digital signal processor (DSP), media access control (MAC) processor, or any other type of communications processor in accordance with the described embodiments. The radio processor 404 may perform analog and/or digital baseband operations for the mobile computing device 400. For example, the radio processor 404 may perform digital-to-analog conversion (DAC), analog-to-digital conversion (ADC), modulation, demodulation, encoding, decoding, encryption, decryption, and so forth.

The mobile computing device 400 may comprise a memory 424 coupled to the radio processor 404. The memory 424 may be implemented using any of the computer-readable media described with reference to the memory 410. The memory 424 may be typically implemented as flash memory and secure digital (SD) RAM. Although the memory 424 may be shown as being separate from the radio processor 404, some or all of the memory 424 may be included on the same IC as the radio processor 404.

The mobile computing device 400 may comprise a transceiver module 426 coupled to the radio processor 404. The transceiver module 426 may comprise one or more transceivers arranged to communicate using different types of protocols, communication ranges, operating power requirements, RF sub-bands, information types (e.g., voice or data), use scenarios, applications, and so forth. In various embodiments, the transceiver module 426 may comprise one or more transceivers arranged to support voice communications and/or data communications for the wireless network systems or protocols as previously described. In some embodiments, the transceiver module 426 may further comprise a Global Positioning System (GPS) transceiver to support position determination and/or location-based services.

The transceiver module 426 generally may be implemented using one or more chips as desired for a given implementation. Although the transceiver module 426 may be shown as being separate from and external to the radio processor 404 for purposes of illustration, it is worthy to note that in various embodiments some portion or the entire transceiver module 426 may be included on the same integrated circuit as the radio processor 404. The embodiments are not limited in this context.

The mobile computing device 400 may comprise an antenna system 428 for transmitting and/or receiving electrical signals. As shown, the antenna system 428 may be coupled to the radio processor 404 through the transceiver module 426. The antenna system 428 may comprise or be implemented as one or more internal antennas and/or external antennas.

The mobile computing device 400 may comprise a subscriber identity module (SIM) 430 coupled to the radio processor 404. The SIM 430 may comprise, for example, a removable or non-removable smart card arranged to encrypt voice and data transmissions and to store user-specific data for allowing a voice or data communications network to identify and authenticate the user. The SIM 430 also may store data such as personal settings specific to the user. In some embodiments, the SIM 430 may be implemented as an UMTS universal SIM (USIM) card or a CDMA removable user identity module (RUIM) card. The SIM 430 may comprise a SIM application toolkit (STK) 432 comprising a set of programmed commands for enabling the SIM 430 to perform various functions. In some cases, the STK 432 may be arranged to enable the SIM 430 to independently control various aspects of the mobile computing device 400.

As mentioned above, the host processor 402 may be arranged to provide processing or computing resources to the mobile computing device 400. For example, the host processor 402 may be responsible for executing various software programs including system programs such as operating system (OS) 434 and application programs 436. System programs generally may assist in the running of the mobile computing device 400 and may be directly responsible for controlling, integrating, and managing the individual hardware components of the computer system. The OS 434 may be implemented, for example, as a Palm OS®, Palm OS® Cobalt, Microsoft® Windows OS, Microsoft Windows® CE OS, Microsoft Pocket PC OS, Microsoft Mobile OS, Symbian OS™, Embedix OS, Linux OS, Binary Run-time Environment for Wireless (BREW) OS, JavaOS, a Wireless Application Protocol (WAP) OS, or other suitable OS in accordance with the described embodiments. The mobile computing device 400 may comprise other system programs such as device drivers, programming tools, utility programs, software libraries, application programming interfaces (APIs), and so forth.

Application programs 436 generally may allow a user to accomplish one or more specific tasks. In various implementations, the application programs 436 may provide one or more graphical user interfaces (GUIs) to communicate information between the mobile computing device 400 and a user. In some embodiments, application programs 436 may comprise upper layer programs running on top of the OS 434 of the host processor 402 that operate in conjunction with the functions and protocols of lower layers including, for example, a transport layer such as a Transmission Control Protocol (TCP) layer, a network layer such as an Internet Protocol (IP) layer, and a link layer such as a Point-to-Point (PPP) layer used to translate and format data for communication.

Examples of application programs 436 may include, without limitation, messaging applications, web browsing applications, personal information management (PIM) applications (e.g., contacts, calendar, scheduling, tasks), word processing applications, spreadsheet applications, database applications, media applications (e.g., video player, audio player, multimedia player, digital camera, video camera, media management), gaming applications, and so forth. Messaging applications may be arranged to communicate various types of messages in a variety of formats. Examples of messaging applications may include without limitation a cellular telephone application, a Voice over Internet Protocol (VoIP) application, a Push-to-Talk (PTT) application, a voicemail application, a facsimile application, a video teleconferencing application, an IM application, an e-mail application, an SMS application, an MMS application, and so forth. It is also to be appreciated that the mobile computing device 400 may implement other types of applications in accordance with the described embodiments.

The host processor 402 may include an audio management module 405. The audio management module 405 may the same or similar to the audio management module 105 described with reference to FIG. 1A.

The mobile computing device 400 may include various databases implemented in the memory 410. For example, the mobile computing device 400 may include a message content database 438, a message log database 440, a contacts database 442, a media database 444, a preferences database 446, and so forth. The message content database 438 may be arranged to store content and attachments (e.g., media objects) for various types of messages sent and received by one or more messaging applications. The message log 440 may be arranged to track various types of messages which are sent and received by one or more messaging applications. The contacts database 442 may be arranged to store contact records for individuals or entities specified by the user of the mobile computing device 400. The media database 444 may be arranged to store various types of media content such as image information, audio information, video information, and/or other data. The preferences database 446 may be arranged to store various settings such as rules and parameters for controlling the operation of the mobile computing device 400.

In some cases, various embodiments may be implemented as an article of manufacture. The article of manufacture may include a storage medium arranged to store logic and/or data for performing various operations of one or more embodiments. Examples of storage media may include, without limitation, those examples as previously described. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A mobile computing device, comprising:
an audio management module to receive information from a sensor and automatically adjust at least one audio setting based on the information.

2. The mobile computing device of claim 1, the information comprising a characteristic of an object.

3. The mobile computing device of claim 2, the object comprising a human body part.

4. The mobile computing device of claim 1, wherein automatically adjusting at least one audio setting comprises changing an output volume of at least one speaker.

5. The mobile computing device of claim 4, wherein the sensor comprises a proximity sensor located in the mobile computing device, the information comprises a distance between the proximity sensor and an object, and the output volume of the mobile computing device is adjusted in response to a change in distance between the sensor and the object.

6. The mobile computing device of claim 5, wherein the output volume is increased as the distance between the proximity sensor and the object increases and decreased as the distance between the proximity sensor and the object decreases.

7. The mobile computing device of claim 4 wherein the sensor comprises a thermal sensor located in the mobile computing device, the information comprises a temperature of an object near the sensor, and the output volume of the mobile computing device is adjusted in response to a change in temperature measured at the temperature sensor.

8. The mobile computing device of claim 7, wherein the output volume is increased as temperature measured at the temperature sensor decreases and decreased as temperature measured at the temperature sensor increases.

9. The mobile computing device of claim 1, wherein automatically adjusting at least one audio setting comprises selecting a first audio mode or a second audio mode.

10. The mobile computing device of claim 9, the first audio mode comprises a close range audio mode using a first speaker and the second audio mode comprises a broadcast audio mode using a second speaker.

11. The mobile computing device of claim 10, wherein the first or second speaker is located remote from the mobile computing device.

12. The mobile computing device of claim 11, wherein the first or second speaker is located in a Bluetooth headset device in communication range of the mobile computing device.

13. A method, comprising:
receiving information from a sensor; and
automatically adjusting at least one audio setting based on the information.

14. The method of claim 13, comprising:
determining a distance between the sensor and an object; and
adjusting an output volume in response to a change in distance between the sensor and the object.

15. The method of claim 14, comprising:
increasing the output volume as the distance between the sensor and the object increases; and
decreasing the output volume as the distance between the proximity sensor and the object decreases.

16. The method of claim 13, comprising:
adjusting an output volume in response to a change in temperature measured at the sensor.

17. The method of claim 16, comprising:
increasing the output volume as the temperature measured at the sensor decreases; and
decreasing the output volume as temperature measured at the sensor increases.

18. The method of claim 13, comprising:
selecting a first audio mode configured for close range audio operation using a first speaker; or
selecting a second audio mode configured for broadcast audio operation using a second speaker.

19. An article comprising a storage medium containing instructions that if executed enable a system to:
receive information from a sensor; and
automatically adjust at least one audio setting based on the information.

20. The article of claim 19, further comprising instructions that if executed enable the system to:
determine a distance between the sensor and an object; and
adjust an output volume in response to a change in distance between the sensor and the object.

21. The article of claim 20, further comprising instructions that if executed enable the system to:
increase the output volume as the distance between the sensor and the object increases; and
decrease the output volume as the distance between the proximity sensor and the object decreases.

22. The article of claim 19, further comprising instructions that if executed enable the system to:
adjust an output volume in response to a change in temperature measured at the sensor.

23. The article of claim 22, further comprising instructions that if executed enable the system to:
increase the output volume as the temperature measured at the sensor decreases; and
decrease the output volume as temperature measured at the sensor increases.

24. The article of claim 19, further comprising instructions that if executed enable the system to:
select a first audio mode configured for close range audio operation using a first speaker; or
select a second audio mode configured for broadcast audio operation using a second speaker.
